(19) United States
(12) Patent Application Publication
(10) Pub. No.: US 2018/0007865 A1
(43) Pub. Date: Jan. 11, 2018

(54) DOG WEAR AND METHODS OF USE

(71) Applicant: Mozzie Pants, LLC, Seattle, WA (US)

(72) Inventor: Julie E. Korth, Seattle, WA (US)

(21) Appl. No.: 15/629,362

(22) Filed: Jun. 21, 2017

Related U.S. Application Data
(60) Provisional application No. 62/359,342, filed on Jul. 7, 2016.

(51) Int. Cl. A01K 13/00; A01K 23/00

(52) U.S. Cl. CPC A01K 13/007; A01K 23/00

(57) ABSTRACT

Dog wear with specific functions for dogs to aid in house training and other issues relating to dog training, specifically indoor marking and urination. The garment includes a pair of leg covering and can be formed to fit over the front legs or the rear legs of the pet. The garment can help to prevent pet accidents by having an absorbent underside portion. The underside portion may be selectively removable, or in some variations, the underside portion may be fully removed to allow the animal free access to relieve itself while still warming the pet and protecting the pet's skin in cold conditions, or for generally covering wounds or hot spots to allow the user to forgo the typical protective cone.

### CROSS-REFERENCE TO RELATED APPLICATION

This application claims priority in U.S. Provisional Patent Application No. 62/359,342, filed Jul. 7, 2016, which is incorporated herein by reference.

### BACKGROUND OF THE INVENTION

### 1. Field of the Invention

The present invention relates generally to dog wear and methods for use thereof, and more specifically to specialized clothing for dogs.

### 2. Description of the Related Art

Many dogs have trouble learning to become house trained. Existing teaching methods and preventative measures such as indoor dog pads and diapers do not sufficiently prevent indoor marking by untrained dogs. What is needed is specialized dog clothing specifically targeting dogs having house training issues or medical issues affecting their bladder.

Heretofore there has not been available a system or method for dog wear with the advantages and features of the present invention.

### BRIEF SUMMARY OF THE INVENTION

The present invention generally provides dog wear with specific functions for dogs to aid in house training and other issues relating to dog training and to cover wounds and hot spots so that the pet doesn't have to wear a dog cone, specifically indoor marking and urination and females in heat. The garment includes a pair of leg covering and can be formed to fit over the front legs or the rear legs of the pet. The garment can help to prevent pet accidents by having an absorbent underside portion. The underside portion may be selectively removable, or in some variations, the underside portion may be fully removed. Alternatively, the pants may have an open crotch area to allow the animal free access to relieve itself while still warming the pet in cold conditions and for covering wounds, protecting skin, and keeping the animal clean.

### BRIEF DESCRIPTION OF THE DRAWINGS

The drawings constitute a part of this specification and include exemplary embodiments of the present invention illustrating various objects and features thereof.

FIG. 1 is a side-diagrammatic view of an embodiment of the present invention shown in a typical environment being worn by a pet dog.

FIG. 2 is a rear-diagrammatic view thereof.

FIG. 3 is a top-diagrammatic view thereof.

FIG. 4 is a bottom plan view of the embodiment thereof.

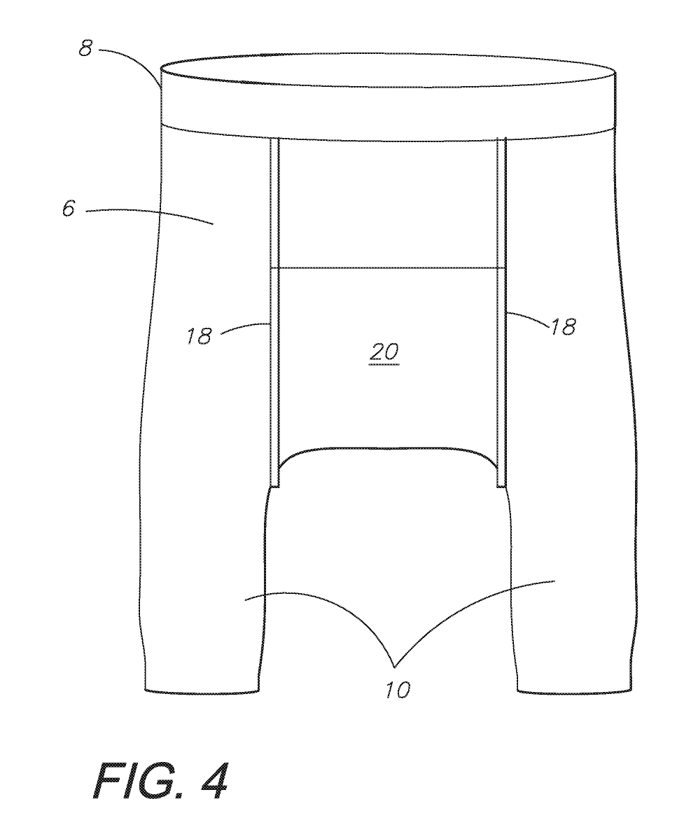

FIG. 5 is a side-diagrammatic view of an alternative embodiment of the present invention shown in a typical environment being worn by a pet dog.

FIG. 6 is a rear-diagrammatic view thereof.

FIG. 7 is a side-diagrammatic view of another alternative embodiment of the present invention shown in a typical environment being worn by a pet dog.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Dog Pants 2

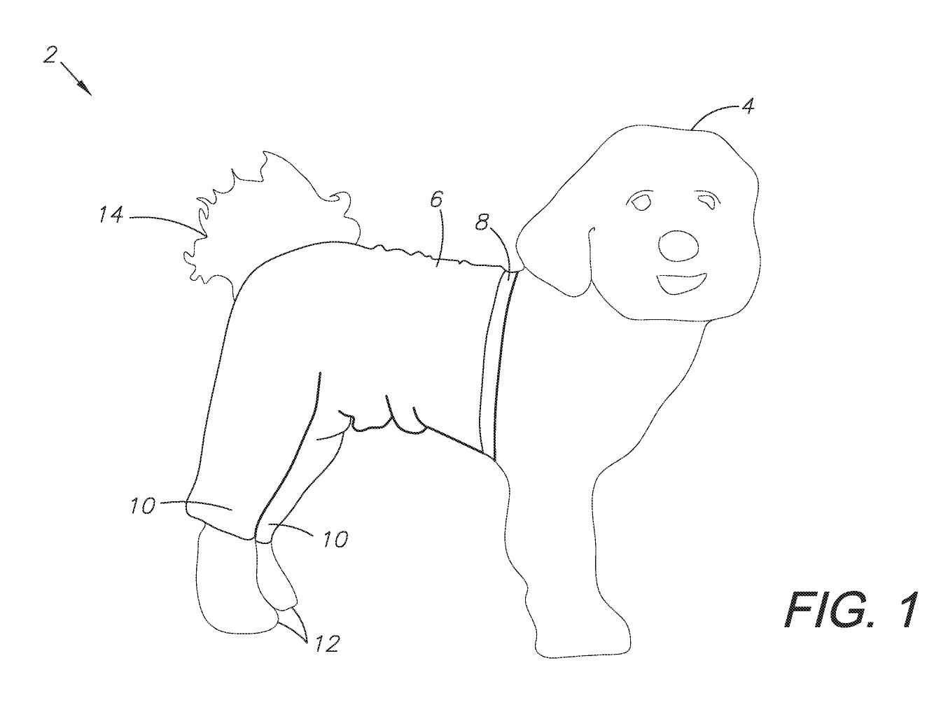

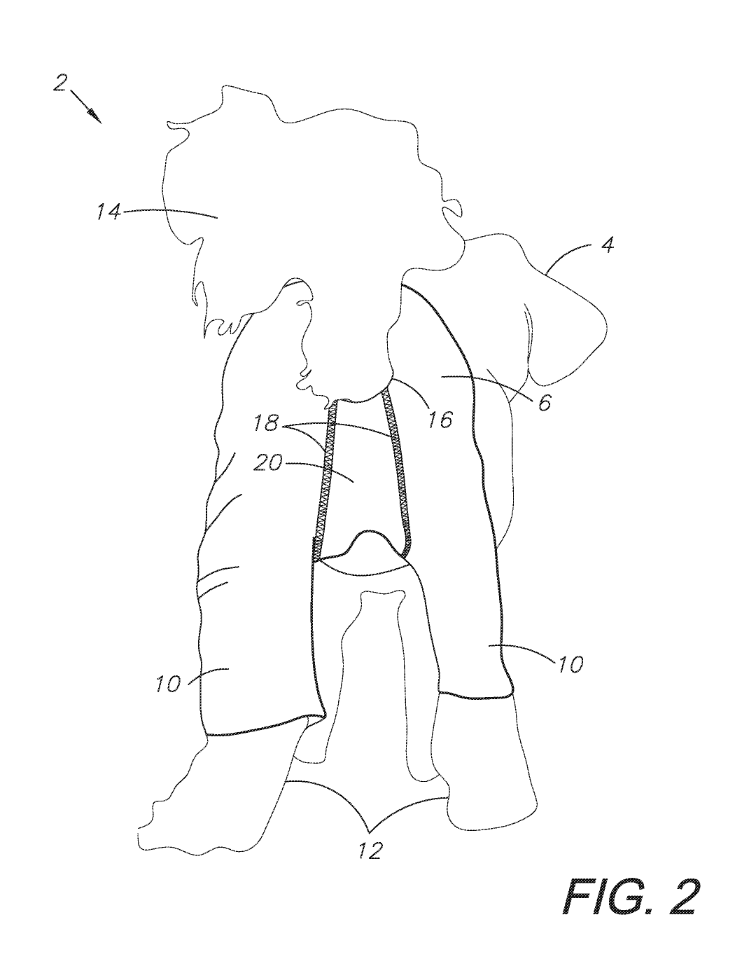

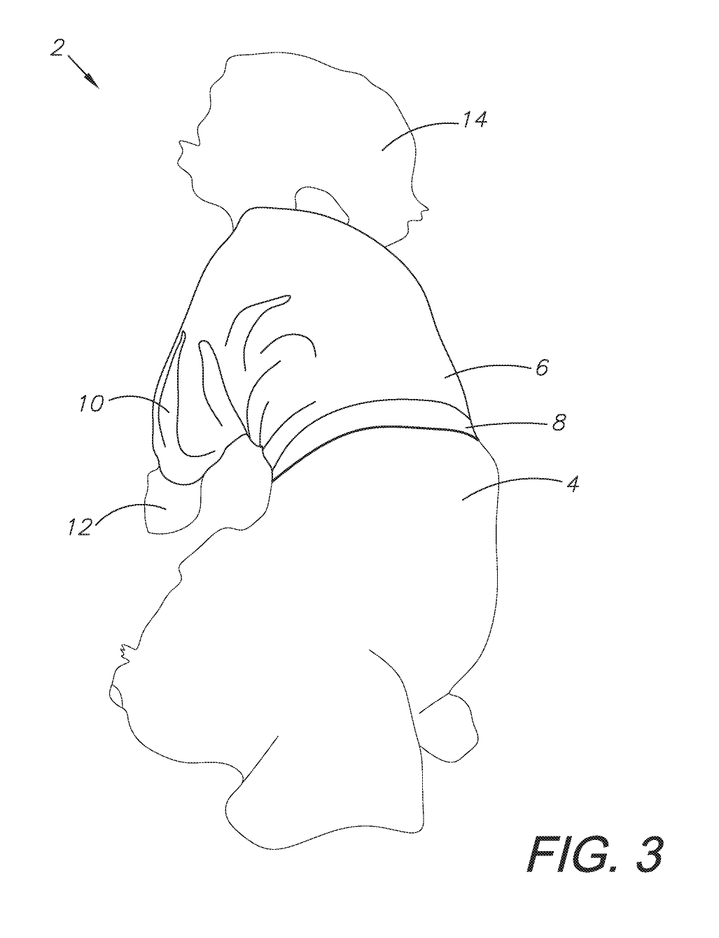

Shown in FIGS. 1-3, a pair of dog pants 2 encompassing a preferred embodiment of the present invention. These pants are meant to help train dogs 4 for housetraining and prevent marking indoors, females in heat, and to cover wounds from surgery and hot spots so that the dreaded cone can be avoided. These pants also serve to help with dogs with nervous bladders or other medical conditions which may make it difficult for a dog to control urination.

The pants 2 include a stretchable waistband 8, such as an elastic band, which secures the pants about the mid-section of the dog. The waistband 8 is connected to one end of the pants body 6, which terminates at the other end into a pair of pant legs 10 which allow the dog's paws 12 to extend therefrom. A hole 16 provides access for the tail 14 to protrude from the pants, preventing discomfort caused by a bunched-up or otherwise bound tail 14. The stitching about the tail hole secures the structural integrity of the pants. The pant legs 10 may include leg tacks that are sewn onto the legs so that they may be trimmed to any desired length.

As shown in the embodiment of FIGS. 1-3, a middle portion 20 is stitched between the two legs 10 of the pant body 6 with seams 18 securing the section together. This middle portion 20 area may be selectively removable, as shown in other embodiments below, or may be reinforced for other purposes.

The pants 2 could be made of denim, cotton, wool, fleece, or any other suitable and typical clothing fabric.

### III. Alternative Embodiment Dog Pants 52

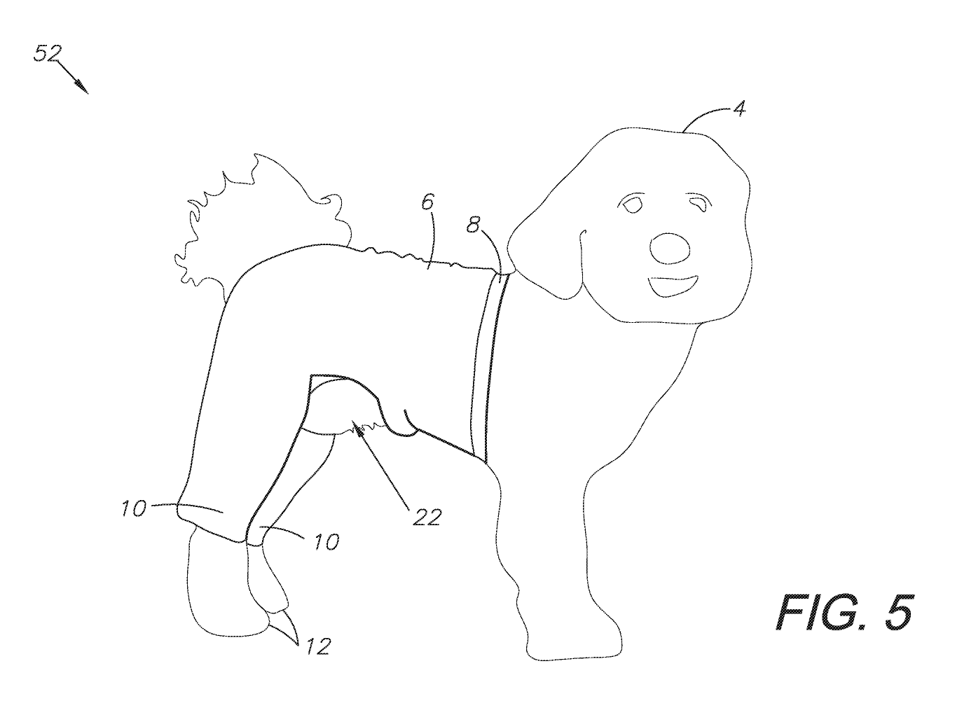

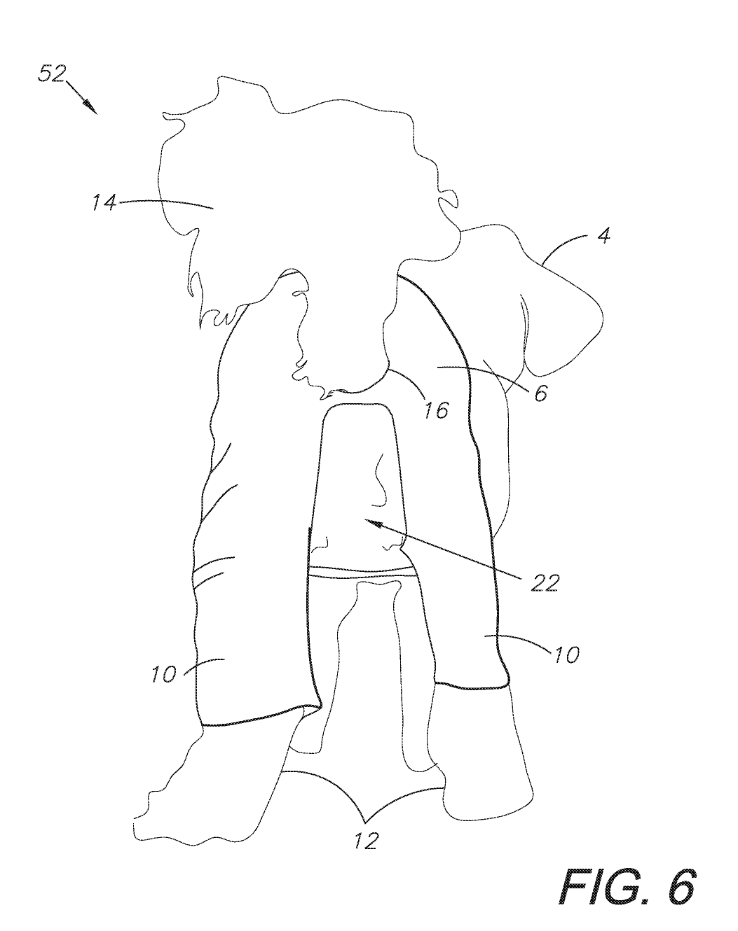

FIGS. 5-6 show a slightly alternative embodiment dog pants 52, which include the same body 6 and stretchable waist band 8, the same legs 10 and tail hole 16, as the embodiment shown above. However, the middle portion of the previous embodiment is instead an opening 22 in this embodiment, allowing the dog to freely relieve itself while wearing the pants 52 without soiling the pants in any way. This can be used to keep the animal warm during cold weather months while allowing normal activity by the animal. These pants 52 cover wounds and hot spots and keep the pups clean during outdoor fun in addition to keeping warm.

### IV. Alternative Embodiment Dog Shirt 102

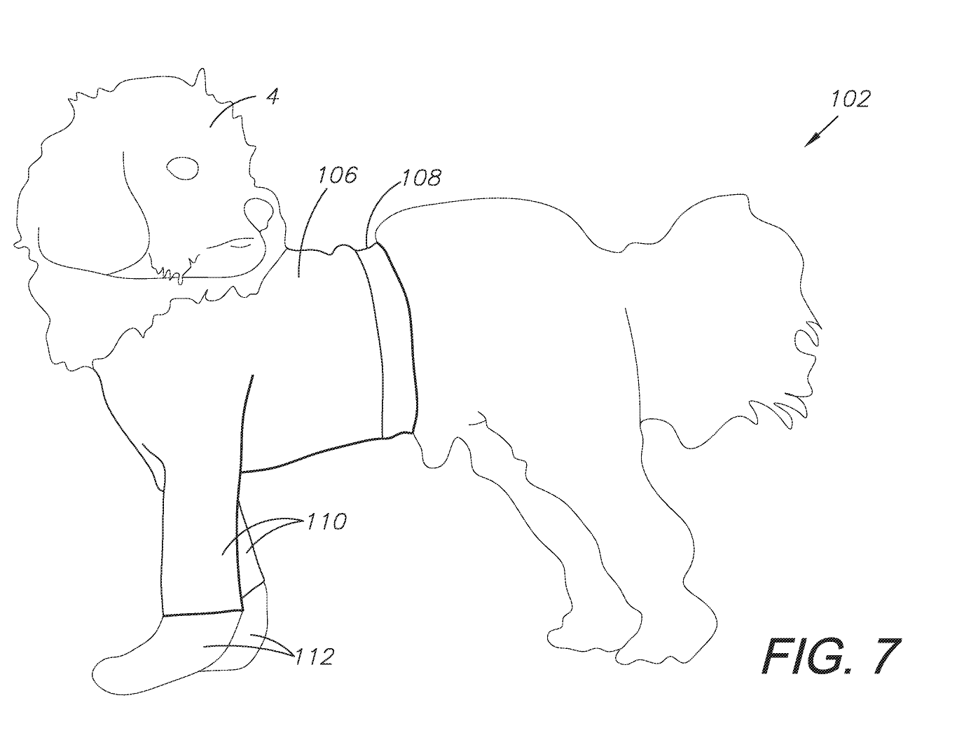

FIG. 7 shows another alternative embodiment of the present invention where the dog wear 102 is shown worn over the front legs 112 of the animal 4. This embodiment is preferable for warmth and comfort of the animal rather than for house training as mentioned above. The garment 102 can cover wounds or hot spots allowing the pet to forego the typical protective cone, thereby preventing licking of skin. Skin allergies can cause hot spots which can be worsened by licking. The garment 102 also keeps the under belly of the pet clean during walks. This embodiment may serve to comfort dogs in times of stress, such as during thunderstorms. The legs 110 of the dog wear 102 cover the front legs 112 of the animal, allowing the paws to be exposed. The elastic waist band 108 is again affixed to the opposite end of the dog wear body 106 from the legs 110, and secures the dog wear 102 about the dog's midsection.

Additional benefits of the embodiments of the present invention shown herein include the ability to cover wounds and hot-spots to prevent the dog from licking or otherwise bothering the wounds without the need of a protective cone. Other benefits include keeping the pet dog clean during walks and out-door play. All embodiments are easily customizable by the end-user by cutting and trimming the leg lengths to fit the pet in question.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A pet garment comprising:
a covering having a torso opening and a pair of leg openings, said torso opening terminating into a stretchable band;
each of said pair of leg openings terminated from a respective pair of garment legs having a first length;
each of said pair of garment legs including leg tacks for selectively shortening said garment legs to a second length;
said covering including a tail hole configured to allow a pet tail to pass through said hole; and
wherein said covering configured to prevent urination accidents and other fluids.

2. The pet garment of claim 1, wherein said pair of leg openings are configured to encompass a rear pair of pet legs.

3. The pet garment of claim 1, wherein said pair of leg openings are configured to encompass a front pair of pet legs.

4. The pet garment of claim 1, further comprising:
said covering having an underside portion terminating in proximity with said tail hole; and
said underside portion configured to absorb pet urine.

5. The pet garment of claim 4, wherein said underside portion is selectively removable.

6. The pet garment of claim 4, further comprising:
an opening along an underside portion of said covering, said opening terminating in proximity with a bottom edge of said tail hole; and
said opening configured to allow said pet to urinate and defecate without soiling said garment.
